(19) United States
(12) Patent Application Publication
(10) Pub. No.: US 2002/0174075 A1
(43) Pub. Date: Nov. 21, 2002

(54) System & method for on-line payment

(75) Inventors: Lev Mirlas, Thornhill (CA); Weidong Kou, Pokfulam (HK); Xiaodong Lin, Kitchener (CA); Johnny Wai-Nang Wong, Waterloo (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/146,306

(22) Filed: May 15, 2002

(30) Foreign Application Priority Data
May 15, 2001 (CA) 2347528

(51) Int. Cl. G06F 17/60

(52) U.S. Cl. 705/78; 705/64

(57) ABSTRACT

In a computer based system and method for on-line payment, a transaction is completed between a shopper and a merchant using one or two trusted third parties. Both the shopper and merchant may use the same trusted third party or each may use its own trusted third party. A trusted third party receives and sends messages to and from the shopper and merchant as well as a payment center. Each message provides encrypted information on the nature of the transaction. The trusted third party does not have the capability to decrypt detailed transaction information and thus is not privy to the nature of the transaction. Should a dispute arise, all parties involved have sufficient encrypted information in the messages to determine the nature of the transaction and the steps concluded.

### FIELD OF THE INVENTION

The present invention relates to a system and method for providing secure and trusted on-line payment for goods or services.

### BACKGROUND OF THE INVENTION

Traditionally the prevalent payment method for on-line shopping has been credit card based. Typically, a shopper transmits credit card information to a merchant using secure communication. A popular method for providing secure communication is secure socket layer (SSL). This method does not require a shopper to sign for the credit card purchase. There is therefore the potential for fraud; e.g., a shopper may use someone else's credit card. Digital signing for credit card purchase is supported by a Secure Electronic Transaction (SET) protocol, which is quite complex in implementation.

A number of methods and systems for providing on-line payment exist. Some of these are discussed in the following paragraphs.

U.S. Pat. No. 6,088,797 discloses a system comprising two tamperproof electronic processing devices, one for a merchant, the other for a customer. Each device is connected to a separate money module. Goods are exchanged electronically between the devices once payment has been exchanged between the money modules. The devices are referred to as trusted agents. Each trusted agent is part of a hierarchy of trusted servers that issue certificates and keys to the trusted agents. The trusted agents also receive a list of other trusted agents as well as untrusted agents. In addition, a trusted server is initialized by a primary trusted server. This hierarchy is unnecessarily complex and requires that each trusted agent have knowledge of who it can and cannot communicate with. Further, the primary trusted server must be aware of all trusted servers and the trusted server must be aware of all trusted agents. Finally the disclosure does not permit a trusted agent to act for both shopper and merchant in the same transaction.

U.S. Pat. No. 5,987,140 discloses a system whereby a client sends all transaction information directly to a merchant. The merchant then interfaces with a payment gateway and informs the customer directly if the transaction has been accepted. Such a system does not provide an audit trail for the user and entrusts the merchant to maintain the confidentiality of user information that he is able to discover.

U.S. Pat. No. 5,790,677 discloses a system and method for secure electronic commerce transactions. Each transaction or set of transactions comprises two phases, a registration phase and a transaction phase. During the registration phase, each participant sends registration information to a central binding server. The server then provides unique keys to each participant. During transmission of data, an originator signs and encrypts the data in a manner that ensures that only the intended registered participants may decrypt the data. Each participant must register and be issued a unique key. Further, registrants must be aware of all eligible recipients for their message. Although data is encrypted, the design of the system provides for others than the final recipient to have access to the data on the assumption that they will not be able to decrypt it and then pass it on to the correct recipient.

U.S. Pat. No. 5,671,279 discloses an electronic transaction system where payment is made by credit card. The main entities in the system are a customer; a merchant and a gateway (e.g. a bank). The implementation of secure channels of communication between the customer and the merchant and the gateway is required. As with U.S. Pat. No. 5,790,677 a single message may contain information intended for distinct parties. Thus each party is capable of reading only the portion of the message intended for them.

There is a need for a system and method of making on-line payments that is secure and that also provides an audit trail on the details of a transaction. The present invention addresses this need.

### SUMMARY OF THE INVENTION

The present invention relates to a system for the on-line purchase and payment of goods or services. The system includes a communication network having a shopper node, a merchant node, a trusted third party node and payment center node. The trusted third party node is the only node communicating with the payment center node.

In accordance with another aspect of the present invention there is provided a method for the on-line purchase of goods or services. A shopper initiates a transaction with a merchant. When the shopper is ready to order, the merchant requests payment information from the shopper. The shopper sends the payment information directly to a trusted third party. The trusted third party queries the merchant for the details of the transaction for the purpose of confirming the transaction. When the merchant returns confirmation of the transaction to the trusted third party, the trusted third party requests payment from a payment center. After receiving payment, the trusted third party informs the merchant that payment has been made and sends a receipt directly to the shopper confirming that payment has been made.

### BRIEF DESCRIPTION OF THE DRAWINGS

FIG. 1 is a data interchange diagram of a first embodiment of the present invention.

FIG. 2 is a data interchange diagram of a second embodiment of the present invention.

### DETAILED DESCRIPTION OF THE INVENTION

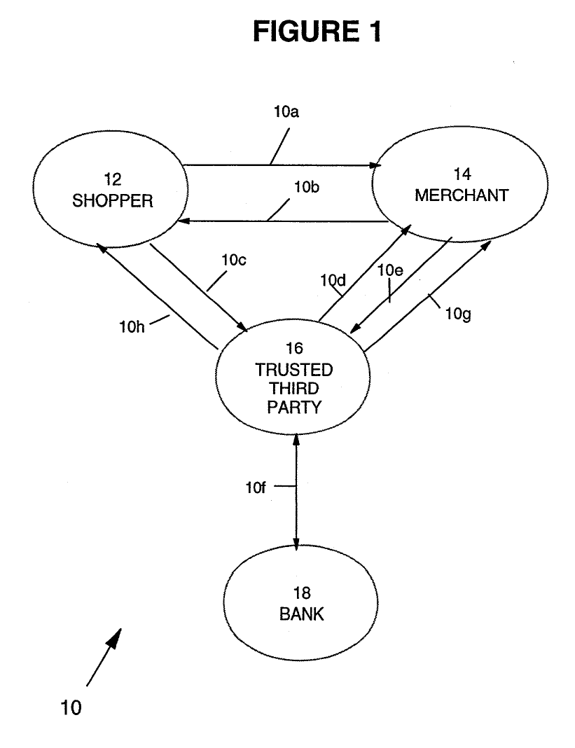

Referring to FIG. 1, a data interchange diagram of a first embodiment of the present invention is shown generally as system 10. System 10 has several nodes, specifically, shopper 12, merchant 14, trusted third party (TTP) 16, and payment center 18. System 10 further comprises data interchanges 10a to 10h.

In system 10, data interchanges 10a to 10h consist of messages that enable shopper 12 to purchase goods or services from merchant 14. A brief overview of data interchanges 10a to 10h follows.

10a) Shopper 12 sends order information to merchant 14;

10b) Merchant 14 requests payment from shopper 12;

10c) Shopper 12 sends payment information and amount of payment to TTP 16;

10d) TTP 16 queries merchant 14 for confirmation of the transaction and the amount of payment;

10e) Merchant 14 returns confirmation;

10f) TTP 16 requests payment from payment center 18 and receives confirmation on payment;

10g) TTP 16 sends receipt to merchant 14 to confirm that payment has been made; and

10h) TTP 16 sends receipt to shopper 12 to confirm that payment has been made.

In a preferred embodiment, the present invention makes use of public key cryptography and public key certification. Any public key certification mechanism can be used; including Pretty Good Privacy (PGP) or a PKI-based Certification Authority. Through the use of cryptography, messages sent between a shopper, a merchant and a TTP are signed, providing a useful confidential audit trail should dispute resolution be required.

A cryptographic message digest of a message is the result of a one-way transformation of the message. A message digest is typically fixed-length, regardless of the length of the original message. A cryptographic message digest function has the following properties:

a) The original message cannot be recovered from the digest;

b) Two different messages are highly unlikely to produce the same digest; and

c) given a message and its digest, it is computationally infeasible to create a second message, which would have the same digest.

One method of creating a digest is through the use of a hash function to transform the original message. As one skilled in the art will understand, there are numerous mathematical transformations that may be utilized to create a digest.

In describing the content of the messages passed in data interchanges, 10a) to 10h) of FIG. 1, the following notation is utilized:

CERT The certificate in the name of “j”, (j=s for shopper, j=m for merchant, j=t for TTP). A certificate may be a PGP public key or some other form of certificate to uniquely identify the party.

H(x) a cryptographic digest of x

Sj(y) Signature on y using private key of (j=s for shopper, j=m for merchant, j=t for TTP)

*abc abc is an optional field

In the preferred embodiment all data interchanges are secured using cryptographic technology, such as Secure Socket Layer (SSL).

The data interchanges 10a to 10h of FIG. 1 will be described in greater detail. In data exchange 10a), shopper 12 sends an “order” message to merchant 14. The “order” message preferably contains the following information: Order=items to be purchased, shipping information, previously quoted price and timestamp. The previously quoted price is an optional field. The timestamp is an optional field included to prevent replay attack, i.e. to avoid a vandal submitting multiple identical orders in an attempt to disrupt the service of merchant 14 or to impersonate the shopper 12.

For data exchange 10b), upon receiving the order message, merchant 14 returns a “payment request” message to shopper 12. The “payment request” message contains the following information: Payment request=transaction ID, amount, order, validity period, CERTₘ,,purchase agreement, Sₘ(transaction ID, amount, order, validity period, CERTₘ, purchase agreement)

The transaction ID is generated by merchant 14, and used by merchant 14 and TTP 16 to keep track of all transactions. The order information is the same as that provided by shopper 12 in data exchange 10a. The validity period specifies the time during which the payment must be confirmed. The certificate of merchant 14 can be used by shopper 12 to verify a digital signature Sₘ of merchant 14. The purchase agreement is an optional field, which contains information such as refund policy, product quality, warranty, or any other information merchant 14 may wish to provide. In data exchange 10c) shopper 12, after verifying the signature of merchant 14, proceeds by sending a “payment” message to TTP 16.

The “payment” message may contain the following information: Payment=payment info, amount, merchant, transaction ID, CERTₛ, timestamp, Sₛ(payment info, amount, merchant, transaction ID, CERTₛ, timestamp)

The payment info field contains payment information, such as a credit card number, card holder ID, and expiration date. The use of a credit card is meant only as an example, any form of information that will allow for electronic payment is considered by the inventors to be within the scope of the invention. Examples include debit cards, bank account numbers and electronic coupons. The transaction ID is the same as that provided by merchant 14 during interchange 10b. The certificate of shopper 12 can be used by TTP 16 to verify the digital signature of shopper 12. Again, an optional timestamp may be included to prevent replay attack. A shopper digital signature Sₛ is included as part of the payment message.

For data exchange 10d), TTP 16, after verifying the signature of shopper 12 in interchange 10c, requests a confirmation from merchant 14 by sending a “confirmation request” message to merchant 14. The “confirmation request” message contains the following information: Confirmation request=transaction ID, amount, status, Sₜ(transaction ID, amount, status)

This message contains the transaction ID, amount, and payment status. A TTP digital signature Sₜ is included as part of the confirmation request message. In data exchange 10e), merchant 14, upon receiving the confirmation request message, verifies the transaction ID and amount, and sends a “transaction confirmed” message to TTP 16.

The “transaction confirmed” message contains the following information: Transaction confirmed=transaction ID, amount, status, Sₘ(transaction ID, amount, status),(H (transaction ID, amount, order, validity period, purchase agreement), Sₘ(H (transaction ID, amount, order, validity period,purchase agreement)))

This message contains the transaction ID, amount, and payment status. As an option, a cryptographic digest of the transaction details (namely transaction ID, order, amount, validity period, purchase agreement), as contained in the payment request message in interchange 10b, may be included. This digest, together with a merchant digital signature of the digest included as part of the transaction confirmed message, will be useful for dispute resolution purposes. A merchant digital signature Sm is included as part of the transaction confirmed message.

Data exchange 10f) is to obtain authorization from a payment center. Upon receiving the transaction confirmed message, TTP 16 requests the authorized amount from payment center 18. Payment center 18 returns an approval to TTP 16. Any payment protocol can be used.

The requirement for payment approval may be tied to the payment policy of TTP 16. It is possible that in some cases (e.g. for preferred customers) TTP 16 would not wait for credit approval, but would process the payment right away. In this case, TTP 16, rather than payment center 18, would take on the responsibility for the payment.

Furthermore, different TTP's 16 may have different policies on handling unknown or delayed credit approval requests. For example, if the approval request times out, TTP 16 may either refuse to process the payment, or may take the risk of processing it. Similarly, even if payment center 18 rejects the request, TTP 16 may still process it, taking on the payment responsibility as described above. This issue is relevant for those payment methods, such as debit card, that do not support payment authorization. In this case, TTP 16 has the choice of taking on payment risk, as described above, or initiating funds capture at this point. However, the latter is only possible in a limited number of cases since TTP 16 has to rely on merchant 14 shipping the goods within a short amount of time. This would be feasible, based on an agreement with merchant 14, where merchant 14 guarantees goods shipment; as is possible, for example, with “soft goods” or goods distributed on-line.

In data interchange 10g) TTP 16 sends a signed “merchant receipt” message to merchant 14. The “merchant receipt” message contains the following information: Merchant receipt=payment ID, transaction ID, amount, Sₜ(payment ID, transaction ID, amount). In data exchange 10h), TTP 16 sends a signed “shopper receipt” message to shopper 12. The “shopper receipt” message contains the following information: Shopper receipt=payment ID, transaction ID, amount, Sₜ(payment ID, transaction ID, amount)

In data interchange 10i) TTP 16 captures the payment and transfers the funds to merchant 14. This final interchange occurs offline, and is not shown in FIG. 1. Interchange 10i involves actual payment capture. For example, if the payment were provided by credit card, TTP 16 would be actually charging the card. The specific payment capture process is beyond the scope of this invention; for example, payment capture could be done weekly as a batch job, or on a per-order basis. TTP 16 may also retain a portion of the payment as fee for the payment service.

As an enhanced version of this payment method, payment is not captured until shipment of the order has been confirmed by merchant 14. For this case, interchange 10i is replaced by the following two interchanges: 10i) Merchant 14 sends a signed “shipment confirmed” message to TTP 16, confirming the shipment of the order. The “shipment confirmed” messaged contains the following information: Shipment confirmation=transaction ID, shipment status, Sₘ (transaction ID, shipment status). In data interchange 10j, TTP 16 captures the payment and transfers the funds to merchant 14.

The above interchanges 10a to 10h are sequential in nature. The transaction is not complete until interchange 10h is performed. A timer is used at each interchange to protect against unusual situations where one of the parties (shopper 12, merchant 14, or TTP 16) is not proceeding with the next interchange within a predetermined time. For interchanges 10a to 10f, if the timer expires, the transaction is assumed to be aborted. Any subsequent messages regarding this transaction will be ignored. Up to this point, any party can abort the transaction by simply not continuing with the next interchange.

At interchange 10g, if merchant 14 does not receive the receipt within a configuration specified time-out period, merchant 14 attempts to obtain the receipt by sending a request message to TTP 16. If a receipt is not received after a pre-specified number of attempts, the transaction is assumed to be aborted. In this case, shopper 12 will not receive the order, but shopper 12 can contact TTP 16 to request a refund.

At interchange 10h, if shopper 12 does not receive the receipt within a time-out period, shopper 12 may request a receipt from TTP 16 at a later time. This would not affect the transaction, as the order will be shipped by merchant 14 as long as merchant 14 has received the receipt.

A description of the steps taken by each of shopper 12, merchant 14 and TPP 16 during a purchase is now provided.

A. Process for Shopper.

Shopper 12 in initiating a process transaction performs the following steps:

A1. Prepare “order” message.

A2. Send “order” message to merchant 14.

A3. Start timer T1.

A4. If T1 expires before “payment request” message is received from merchant, abort the transaction.

A5. Verify signature of merchant 14.

A6. If signature is not valid, abort transaction.

A7. Log “payment request” message.

A8. Prepare “payment” message.

A9. Send “payment” message to TTP 16.

A10. Log “payment” message.

A11. Wait for receipt from TTP 16.

At step A11, if shopper 12 does not receive the receipt within a time-out period, shopper 12 may request a receipt at a later time. This would not affect the transaction because the order will be shipped by merchant 14 as long as merchant 14 has received the receipt.

B. Process of Merchant 14.

Upon receiving an “order” message from shopper the following steps are performed:

B1. Generate transaction ID.

B2. Prepare “payment request” message.

B3. Send “payment request” message to shopper.

B4. Log “payment request” message.

B5. Start timer T2; value of timer is set to the length of the validity period.

B6. If timer T2 expires before “confirmation request” is received from TTP 16, abort transaction.

B7. Verify signature of TTP 16.

B8. If signature is not valid, abort transaction.

B9. If amount paid is not accurate, abort transaction.

B10. Log “confirmation request” message.

B11. Prepare “transaction confirmed” message.

B12. Send “transaction confirmed” message to TTP 16.

B13. Log “transaction confirmed” message.

B14. Start timer T3.

B15. If receipt is received before T3 expires, transaction is completed successfully.

B16. Send a request to TTP 16 for the receipt and restart timer T3. This step is repeated if timer T3 expires again. If a receipt is not received from TTP 16 after a fixed number of attempts, abort transaction.

If the transaction is aborted at B16, shopper 12 will not receive the order, but shopper 12 can contact TTP 16 to request a refund.

If a “confirmation request” message is received from TTP 16 for an order where the validity period has expired (i.e., the corresponding transaction has already been aborted in B6), the confirmation request is simply ignored. For the enhanced version of this payment method where payment is not captured until shipment of the order has been confirmed by merchant 14, a merchant 14 signed “shipment confirmed” message is sent to TTP 16 at step B15 if the receipt is received before T3 expires.

C. Process of TTP 16.

Upon receiving a “payment” message from shopper 12 the following steps are performed:

C1. Verify signature of shopper 12.

C2. If signature is not valid, ignore message.

C3. Log “payment” message.

C4. Prepare “confirmation request” message.

C5. Send “confirmation request” message to merchant 14.

C6. Log “confirmation request” message.

C7. Start timer T4.

C8. If timer T4 expires before “transaction confirmed” is received from merchant 14, abort transaction.

C9. Verify signature of merchant 14.

C10. If signature is not valid, abort transaction.

C11. Log “transaction confirmed” message.

C12. Request authorization from payment center 18 using secure communications, for payment of the confirmed transaction.

C13. If amount is not approved by payment center 18, abort transaction.

C14. Send receipt to merchant 14.

C15. Send receipt to shopper 12.

For C14, additional actions may be required if the receipt is not delivered within the time-out period set by merchant 14. These actions are outlined in B16 of process of merchant 14 above.

For C15, additional actions may be required if the receipt is not delivered within the time-out period set by shopper 12. These actions are outlined in the discussion of step A11 in the process for shopper 12, above.

If a message is received from merchant 14 asking for a receipt for a transaction that has been aborted, the message is ignored. This can happen if timer T4 has expired at C8 or transaction has been aborted at C10 or C13, and subsequently, a request for receipt is received as a result of step B16 of process of merchant 14.

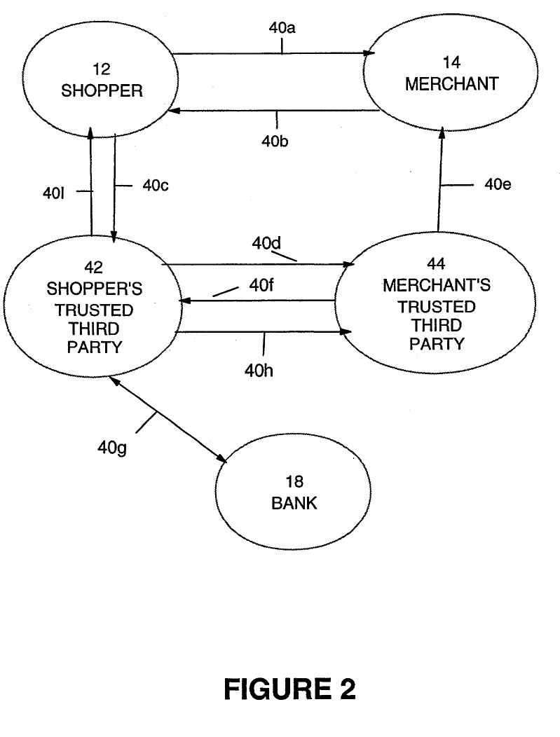

Referring now to FIG. 2a data interchange diagram of a second embodiment of the present invention is shown generally as 40.

System 40 has nodes for shopper 12, merchant 14 and payment center 18 which are identical to corresponding nodes in system 10. However, rather than the single node TTP 16 of system 10, system 40 utilizes two trusted third party nodes; namely, shopper's trusted third party (TTP-s) 42 and merchant's trusted third party (TTP-m) 44.

The definition of Sⱼ(y) is extended to include TTP-s and TTP-m. That is, Sⱼ(y) is a digital signature on y using private key of j(j=s for shopper, j=m for merchant, j=ts for TTP-s, j=tm for TTP-m). All other definitions provided in describing system 10 remain the same.

In system 40, data interchanges 40a to 40k consist of messages that enable shopper 12 to purchase goods or services from merchant 14. A brief overview of data interchanges 40a to 40k follows.

40a) Shopper 12 sends the order information to merchant 14;

40b) Merchant 14 requests payment from shopper 12;

40c) Shopper 12 sends payment information and amount of payment to trusted third party TTP-s 42;

40d) TTP-s 42 checks with TTP-m 44 to get a confirmation of transaction and the amount of payment;

40e) TTP-m 44 checks with merchant 14 to get a confirmation of transaction and the amount of payment;

40f) Merchant 14 returns a confirmation to TTP-m 44;

40g) TTP-m 44 returns confirmation to TTP-s 42;

40h) TTP-s 42 requests the authorized amount from payment center 18, and payment center 18 issues the credit;

40i) TTP-s 42 sends a receipt to TTP-m 44 to confirm that payment has been made;

40j) TTP-m 44 forwards the receipt to merchant 14; and

40k) TTP-s 42 sends a receipt to the shopper to confirm that payment has been made.

As with system 10, in the preferred embodiment of system 40, all data interchanges are secured using cryptographic technology, such as Secure Socket Layer (SSL).

The content of the data interchanges 40a to 40k of FIG. 2 will be described in more detail below. In 40a) Shopper 12 sends an “order” message to merchant 14. The “order” message may contain the following information: Order=items to be purchased, shipping information, previously quoted price, timestamp. The previously quoted price is an optional field. The timestamp is an optional field included to prevent replay attack.

In 40b) Merchant 14, upon receiving the order message, returns a “payment request” message to shopper 12. The “payment request” message contains the following information: Payment request=transaction ID, amount, order, validity period, CERTₘ, purchase agreement, TTP-m, Sₘ(transaction ID, amount, order, validity period, CERTₘ,purchase agreement, TTP-m)

The transaction ID is generated by merchant 14, and used by merchant 14, TTP-s 42 and TTP-m 44 to keep track of all the transactions. The order information is the same as that provided by shopper 12. The validity period specifies the time during which the payment must be confirmed. The certificate of merchant 14 can be used by shopper 12 to verify the signature of merchant 14. The purchase agreement is an optional field, which contains information such as refund policy, product quality, warranty, or other information as determined by the merchant. TTP-m is the identity and address of the TTP-m 44 that merchant 14 wants to use. A merchant digital signature Sₘ is included as part of the payment request message.

In 40c) Shopper 12, after verifying the signature of merchant 14, proceeds by sending a “payment” message to TTP-s 42. The “payment” message contains the following information: Payment=payment info, amount, merchant, transaction ID, CERTs, TTP-m, timestamp, Sₛ(payment info, amount, merchant, transaction ID, CERTs, TTP-m, timestamp) The payment info field contains payment information, such as the credit card number, card holder ID, and expiration date.

The use of a credit card is meant only as an example, any form of information that will allow for electronic payment is considered by the inventors to be within the scope of the invention. Examples include debit cards, bank account numbers and electronic coupons. The transaction ID is the same as that provided by merchant 14. The certificate of shopper 12 can be used by TTP-s 42 to verify the signature of shopper 12. TTP-m indicates a specific TTP-m 44 used by merchant 14. Again, an optional timestamp may be included to prevent replay attack. A shopper digital signature Sₛ is included as part of the payment message.

In 40d), TTP-s 42, after verifying the signature of shopper 12, requests a confirmation from TTP-m 44 by sending a “TTP-s confirmation request” message to TTP-m 44. The “TTP-s confirmation request” message contains the following information: TTP-s confirmation request=transaction ID, amount, status, merchant, Sₜₛ(transaction ID, amount, status, merchant). This message contains the transaction ID, amount, merchant identification, and payment status. A TTP-s digital signature Sts is included as part of the TTP-s confirmation request message.

In 40e) TTP-m 44, after verifying the signature of TTP-s 42, requests a confirmation from merchant 14 by sending a “TTP-m confirmation request” message to merchant 14. The “TTP-m confirmation request” message contains the following information: TTP-m confirmation request=transaction ID, amount, status, Sₜₘ (transaction ID, amount, status). This message contains the transaction ID, amount, and payment status. A TTP-m digital signature Sₜₘ is included as part of the TTP-m confirmation request message.

In 40f) Merchant 14, upon receiving the TTP-m confirmation request message, verifies the transaction ID and amount, and sends “merchant transaction confirmed” message to TTP-m 44. The “merchant transaction confirmed” message contains the following information: Merchant transaction confirmed=transaction ID, amount, status, Sₘ (transaction ID, amount, status), (H (transaction ID, amount, order, validity period, purchase agreement), Sₘ (H (transaction ID, amount, order, validity period, purchase agreement))). This message contains the transaction ID, amount, and payment status.

As an option, a cryptographic digest of the transaction details (namely transaction ID, order, amount, validity period, purchase agreement), as contained in the payment request message in interchange 40b, may be included. This digest, together with a merchant digital signature of the digest included as part of the transaction confirmed message, will be useful for dispute resolution purposes. A merchant digital signature Sₘ is included as part of merchant 14 transaction confirmed message.

In interchange 40g) TTP-m 44, upon receiving merchant 14 transaction confirmed message from merchant 14, verifies the transaction ID and amount, and sends a “TTP-m transaction confirmed” message to TTP-s 42. The “TTP-m transaction confirmed” message contains the following information: TTP-m transaction confirmed=transaction ID, amount, status, Sₜₘ (transaction ID, amount, status), (H (transaction ID, amount, order, validity period, purchase agreement), Sₜₘ (H (transaction ID, amount, order, validity period, purchase agreement))).

This message contains the transaction ID, amount, and payment status. The digest of the transaction details (namely transaction ID, order, amount, validity period, purchase agreement), is the same as that provided by merchant 14. This digest will be useful for dispute resolution purposes. A TTP-m digital signature Sₜₘ is included as part of the TTP-m transaction confirmed message.

Interchange 40h) is to obtain authorization from payment center. Upon receiving the transaction confirmed message, TTP-s 42 requests the authorized amount from payment center 18. Payment center 18 returns an approval to TTP-s 42. Any payment protocol can be used.

The requirement for payment approval is determined by the policy of TTP-s 42. It is possible that in some cases (e.g. for preferred customers) TTP-s 42 would not wait for credit approval, but would process the payment right away. In this case, TTP-s 42, rather than payment center 18, would be taking on the responsibility for the payment.

Furthermore, each TTP-s 42 may have different policies on handling unknown or delayed credit approval requests. For example, if the approval request times out, TTP-s 42 may either refuse to process the payment or may take the risk of processing it. Similarly, even if payment center 18 rejects the request, TTP-s 42 may still process it, taking on the payment responsibility as described above. This issue is relevant for those payment methods, such as debit card, that do not support payment authorization. In this case, TTP-s 42 has the choice of taking on payment risk, as described above or initiating funds capture at this point. However, the latter is only possible in a limited number of cases since TTP-2 42 has to rely on merchant 14 shipping the goods within a short amount of time. This would be feasible, based on an agreement with merchant 14, where merchant 14 guarantees goods shipment; as is possible, for example, with “soft goods” or goods distributed online.

In interchange 40i) TTP-s 42 sends a signed “merchant receipt” message to TTP-m 44. The “merchant receipt” message contains the following information: Merchant receipt=payment ID, transaction ID, amount, merchant, Sₜₛ (payment ID, transaction ID, amount, merchant).

In interchange 40j) TTP-m 44 verifies the receipt and sends a signed “merchant receipt” message to merchant 14. The “merchant receipt” message contains the following information: Merchant receipt=payment ID, transaction ID, amount, Sₜₘ (payment ID, transaction ID, amount).

In interchange 40k) TTP-s 42 sends a signed “shopper receipt” message to shopper 12. The “shopper receipt” message contains the following information: Shopper receipt=payment ID, transaction ID, amount, Sₜₛ (payment ID, transaction ID, amount).

In interchange 40l) TTP-s 42 captures the payment and the funds are transferred to TTP-m 44. This last step happens offline, is not shown in FIG. 2, and involves actual payment capture. For example, if the payment were done by credit card, TTP-s 42 would be actually charging the card. The specific payment capture process is beyond the scope of this invention; for example, payment capture could be done weekly as a batch job or on a per-order basis.

The description of how TTP-s 42 transfers the funds to merchant 14 is also beyond the scope of this invention. TTP-s 42 may in fact transfer the funds to TTP-m 44, which in turn would transfer the funds to merchant 14. TTP-s 42 and TTP-m 44, may in the end retain a portion of the payment as fee for the payment service.

As an enhanced version of this payment method, payment is not captured until shipment of the order has been confirmed by merchant 14. For this case, interchange 40l is replaced by the following three interchanges

40l) Merchant 14 sends a signed “shipment confirmed” message to TTP-m 44, confirming the shipment of the order. The “shipment confirmed” messaged contains the following information: Shipment confirmation=transaction ID, shipment status, Sₘ (transaction ID, shipment status).

40m) TTP-m 44 forwards the “shipment confirmed” message to TTP-s 42, confirming the shipment of the order.

40n) TTP-s 42 captures the payment and the funds are transferred to TTP-m 44.

Interchanges 40a to 40k are sequential in nature. The transaction is not complete until the last step (40k) is performed. A timer is used at each step to protect against unusual situations where one of the parties (shopper 12, merchant 14, TTP-s 42 or TTP-m 44) is not proceeding with the next step within a predetermined time. For interchanges 40a to 40h, if the timer expires, the transaction is assumed to be aborted. Any subsequent messages regarding this transaction will be ignored. Up to this point, any party can abort the transaction by simply not continuing with the next step.

At interchange 40i), if TTP-m 44 does not receive the receipt within a configuration specified time-out period, TTP-m 44 attempts to obtain the receipt by sending a request message to TTP-s 42. If a receipt is not received after a pre-specified number of attempts, the transaction is assumed to be aborted. In this case, shopper 12 will not receive the order, but shopper 12 can contact TTP-s 42 to request a refund.

At interchange 40j if merchant 14 does not receive the receipt within a configuration specified time-out period, merchant 14 attempts to obtain the receipt by sending a request message to TTP-m 44. If a receipt is not received after a pre-specified number of attempts, the transaction is assumed to be aborted. In this case, shopper 12 will not receive the order, shopper 12 can contact TTP-s 42 to request a refund.

At interchange 40k, if shopper 12 does not receive the receipt within a time-out period, shopper 12 may request a receipt from TTP-s 42 at a later time. This would not affect the transaction because the order will be shipped by merchant 14 as long as merchant 14 has received the receipt.

A description of the steps taken by each of shopper 12, merchant 14 TTP-s 42 and TTP-m 44 during a purchase is now provided.

A. Process of Shopper 12. When shopper 12 initiates a process transaction, the following steps occur:

A1. Prepare “order” message.

A2. Send “order” message to merchant 14.

A3. Start timer T1.

A4. If T1 expires before “payment request” message is received from merchant 14, abort the transaction.

A5. Verify signature of merchant 14.

A6. If signature is not valid, abort transaction.

A7. Log “payment request” message.

A8. Prepare “payment” message.

A9. Send “payment” message to TTP-s 42.

A10. Log “payment” message.

A11. Wait for receipt from TTP-s 42.

At A11, if shopper 12 does not receive the receipt within a time-out period, shopper 12 may request a receipt at a later time. This would not affect the transaction because the order will be shipped by merchant 14 as long as merchant 14 has received the receipt.

B. Process for Merchant 14. Upon receiving an “order” message from shopper 12, the following steps occur:

B1. Generate transaction ID.

B2. Prepare “payment request” message.

B3. Send “payment request” message to shopper 12.

B4. Log “payment request” message.

B5. Start timer T2; value of timer is set to the length of the validity period.

B6. If timer T2 expires before “TTP-m confirmation request” is received from TTP-m 44, abort transaction.

B7. Verify signature of TTP-m 44.

B8. If signature is not valid, abort transaction.

B9. If amount paid is not accurate, abort transaction.

B10. Log “TTP-m confirmation request” message.

B11. Prepare “merchant transaction confirmed” message.

B12. Send “merchant transaction confirmed” message to TTP-m 44.

B13. Log “merchant transaction confirmed” message.

B14. Start timer T3.

B15. If receipt is received before T3 expires, transaction is completed successfully.

B16. Send a request to TTP-m 44 for the receipt and restart timer T3. This step is repeated if timer T3 expires again. If a receipt is not received from TTP-m 44 after a fixed number of attempts, abort transaction. If the transaction is aborted at B16, shopper 12 will not receive the order, but shopper 12 can contact TTP-s 42 to request a refund.

If a “TTP-m confirmation request” message is received from TTP-m 44 for an order where the validity period has expired (i.e., the corresponding transaction has already been aborted in B6), the TTP-m confirmation request is simply ignored. For the enhanced version of this payment method where payment is not captured until shipment of the order has been confirmed, a signed “shipment confirmed” message is sent to TTP-m 44 at step B15 if the receipt is received before T3 expires.

C. Process for TTP-s 42. Upon receiving a “payment” message from shopper 12, the following steps occur:

C1. Verify signature of shopper 12.

C2. If signature is not valid, ignore message.

C3. Log “payment” message.

C4. Prepare “TTP-s confirmation request” message.

C5. Send “TTP-s confirmation request” message to TTP-m 44.

C6. Log “TTP-s confirmation request” message.

C7. Start timer T4.

C8. If timer T4 expires before “TTP-m transaction confirmed” message is received from TTP-m 44, abort transaction.

C9. Verify signature of TTP-m 44.

C10. If signature is not valid, abort transaction.

C11. Log “TTP-m transaction confirmed” message.

C12. Request authorization from payment center 18 using secure communications, for the payment of the confirmed transaction.

C13. If amount is not approved by payment center 18, abort transaction.

C14. Send receipt to TTP-m 44.

C15. Send receipt to shopper 12.

For C14, additional actions may be required if the receipt is not delivered within the time-out period set by TTP-m 44. These actions are outlined in step D15 of the Process for TTP-m 44 section, which follows.

For C15, additional actions maybe required if the receipt is not delivered within the time-out period set by shopper 12. These actions are outlined in the discussion of step A11 in the process of shopper 12 section, above.

If a message is received from TTP-m 44 asking for a receipt for a transaction that has been aborted, the message is ignored. This can happen if timer T4 has expired at C8 or the transaction has been aborted at C8, C10 or C13, and subsequently, a request for receipt is received because of step B16 of the Process of Merchant 14, see above.

D. Process of TTP-m 44. Upon receiving a “TTP-s confirmation request” message from the TTP-s 42, the following steps are taken:

D1. Verify signature of TTP-s 42.

D2. If signature is not valid, ignore message.

D3. Log “TTP-s confirmation request” message.

D4. Prepare “TTP-m confirmation request” message.

D5. Send “TTP-m confirmation request” message to merchant 14.

D6. Log “TTP-m confirmation request” message.

D7. Start timer T5.

D8. If timer T5 expires before “merchant transaction confirmed” message is received from merchant 14, abort transaction.

D9. Verify signature of merchant 14.

D10. If signature is not valid, abort transaction.

D11. Log “merchant transaction confirmed” message.

D12. Prepare “TTP-m transaction confirmed” message.

D13. Send “TTP-m transaction confirmed” message to the TTP-s 42.

D14. Start timer T6.

D15. If timer T6 expires before receipt is received from TTP-s 42, send a request to TTP-s 42 for the receipt and restart timer T6. This step is repeated if timer T6 expires again. If a receipt is not received from TTP-s 42 after a fixed number of attempts, abort transaction.

D16. Send receipt to merchant 14.

For D16, additional actions may be required if the receipt is not received by merchant 14 within the time-out period set by merchant 14. These actions are outlined in step B16 of the Process of Merchant section above.

For the enhanced version of this payment method where payment is not captured until shipment of the order has been confirmed by merchant 14, an extra step is added after D16, namely, when a “shipment confirmed” message is received from the merchant, this message is forwarded to TTP-s 42.

If a message is received from merchant 14 asking for a receipt for a transaction that has been aborted, the message is ignored. This can happen if timer T5 has expired at D8 or transaction has been aborted at D10 or D15, and subsequently, a request for receipt is received because of step B16 of the Process of Merchant 14.

In case of dispute, shopper 12 has a signed payment request from merchant 14 and a signed receipt from a TTP (16 or 42). Merchant 14 has a signed receipt from a TTP (16 or 44). The TTP (16, 42 or 44) has a signed payment from shopper 12 and a signed confirmation from merchant 14. The above information is sufficient for dispute resolution purposes.

Throughout the specification and the claims, when the inventors refer to the use of a credit card or other form of payment they simply refer to one example of payment. Any form of electronic payment is intended by the inventors to be considered, including direct payment center account numbers, debit cards, smart cards and any other form of negotiable instrument in the electronic medium.

Throughout the disclosure and claims, when the inventors refer to payment center 18 they intend to include all businesses that may recognize the credit of shopper 12 to pay for the purchase. For example, payment center 18 may include any number of institutions such as banks, credit card companies or credit unions. Further, a payment center 18 may further include existing networks that accept electronic payments, such as Interact or Cirrus. In essence, to the inventors, payment center 18 is someone who will authorize payment for a purchase.

Although FIGS. 1 and 2 show only a single shopper 12 and merchant 14 there can of course be many shoppers 12 and merchants 14 all utilizing the invention with a variety of TTP's of their choice. Thus the present invention allows each party to be represented by their own TTP. Further, a single TTP may represent more than one shopper 12 and/or merchant 14. The present invention does not require shopper 12 or merchant 14 to register with a TTP to utilize the invention.

As can be appreciated by one skilled in the art, shopper 12, merchant 114, payment center 18 and TTP's (16, 42, and 44) can all be viewed as nodes on a network. The nature of the network may be based upon the Internet, or it may utilize a protocol other than TCP/IP, perhaps proprietary. It may be wireless or wired. The point here being that to work the present invention it is merely necessary that some form of network exist to connect the above listed entities or nodes. One skilled in the art of the network utilized will be able to format the message data for the interchanges as described.

Although the format of the messages for each interchange in the network has been specified, one skilled in the art may easily modify the content of a message yet remain within the scope of the invention. For example, in some implementations message fields such as “validity period” may be programmed into the nodes, similarly a “transaction id” may be eliminated by using a timestamp or other means.

Although the invention has been described with reference to certain specific embodiments, various modifications thereof will be apparent to those skilled in the art without departing from the spirit and scope of the invention as outlined in the claims appended hereto.

What is claimed is:

1. A system for the on-line purchase and payment of goods or services, said system comprising a communication network, said network comprising a shopper node, a merchant node, a trusted third party node and payment center node; said trusted third party node being the only node communicating with said payment center node.

2. The system of claim 1 wherein said trusted third party node comprises a shopper's trusted third party node and a merchant's trusted third party node; said shopper's third party node being the only node communicating with said payment center node.

3. The system of claim 1 comprising a plurality of nodes selected from the set consisting of: shopper node, merchant node, trusted third party node and payment center node.

4. The system of claim 2 comprising a plurality of nodes selected from the set consisting of: shopper node, merchant node, shopper's trusted third party node, merchant's trusted third party node and payment center node.

5. The system of claim 1 wherein said trusted third party node may be utilized by a plurality of shoppers and a plurality of merchants.

6. The system of claim 2 wherein said shopper's trusted third party node may be utilized by a plurality of shoppers and said merchant's trusted third party node may be utilized by a plurality of merchants.

7. A method for the on-line purchase of goods or services said method comprising the steps of:
a) enabling a shopper to initiate a transaction with a merchant;
b) enabling said merchant to request payment from said shopper;
c) enabling said shopper to send payment information to a trusted third party;
d) enabling said trusted third party to query said merchant on the details of said transaction for the purpose of confirming said transaction;
e) enabling said merchant returning confirmation of said transaction to said trusted third party;
f) enabling said trusted third party to request payment from a payment center;
g) enabling said trusted third party to inform said merchant that said payment has been made; and
h) enabling said trusted third party sending a receipt to said shopper confirming that said payment has been made.

8. The process of claim 7 wherein at step b) said merchant transmits to said shopper: a transaction identifier, an amount, order data, an encryption certificate and a digital signature.

9. The process of claim 7 wherein at step c) said shopper transmits to said trusted third party: a transaction identifier, an amount, a merchant identifier, an encryption certificate and a digital signature.

10. The process of claim 7 wherein at step e) said merchant transmits to said trusted third party: a transaction identifier, an amount, a status and a cryptographic digest containing details on said transaction.

11. A method for the on-line purchase of goods or services said method comprising the steps of:
a) enabling a shopper to initiate a transaction with a merchant;
b) enabling said merchant to request payment from said shopper;
c) enabling said shopper to send payment information to a shopper trusted third party;
d) enabling said shopper trusted third party to query a merchant trusted third party on the details of said transaction for the purpose of confirming said transaction;
e) enabling said merchant trusted third party to query said merchant on the details of said transaction for the purpose of confirming said transaction;
f) enabling said merchant to return confirmation of said transaction to said merchant trusted third party;
g) enabling said merchant trusted third party to return said confirmation to said shopper trusted third party;
h) enabling said shopper trusted third party to request payment from a payment center;
i) enabling said shopper trusted third party to inform said merchant trusted third party that payment has been made;
j) enabling said merchant trusted third party to inform said merchant that payment has been made; and
k) enabling said shopper trusted third party to send a receipt to said shopper confirming that said payment has been made.

12. A method for the on-line purchase and payment of goods or services, said method comprising the steps of:
a) enabling a shopper to initiate a transaction with a merchant;
b) enabling said merchant to acknowledge said transaction;
c) enabling said shopper and said merchant to interact with a single trusted third party to complete said transaction; and
d) enabling said trusted third party to confirm payment for said transaction with a payment center.

13. The method of claim 12 wherein said shopper interacts with a shopper's trusted third party and said merchant interacts with a merchant's trusted third party.

14. The method of claim 12 wherein messages between said merchant and said trusted third party include a cryptographic digest.

15. The method of claim 13 wherein messages between said merchant and said merchant's trusted third party include a cryptographic digest.

16. The method of claims 12 and 13 wherein messages between said shopper, said merchant, and said trusted third party are digitally signed.

17. The method of claim 1 wherein messages between said merchant node and said trusted third party node include a cryptographic digest.

18. A computer program for enabling the payment of on-line transactions, said program comprising:
a) program code for enabling a shopper to contact a merchant;
b) program code for enabling a merchant to contact a shopper;
c) program code for enabling said merchant and said shopper to communicate with a trusted third party; and
d) program code for enabling said trusted third party to communicate with a payment center.

19. The program of claim 18 wherein messages between said shopper, said merchant, said trusted third party and said payment center may be digitally signed.

20. The program of claim 18 wherein messages between said merchant and said trusted third party may include a cryptographic digest.

21. The program of claim 18 wherein said merchant and said shopper may each have a different trusted third party.

22. The program of claim 18 wherein said program is encoded in a computer readable medium.

23. The method of claim 12 wherein said method is encoded in a computer readable medium.
